(19) United States
(12) Patent Application Publication
(10) Pub. No.: US 2022/0065357 A1
(43) Pub. Date: Mar. 3, 2022

(54) BACKFLOW PREVENTION DEVICE

(71) Applicant: KYLIN SANITARY TECHNOLOGY (XIAMEN) CO., LTD., Xiamen City (CN)

(72) Inventors: Zhibin Chen, Xiamen City (CN); Qingshuang Li, Xiamen City (CN); Hui Huang, Xiamen City (CN)

(21) Appl. No.: 17/108,518

(22) Filed: Dec. 1, 2020

(30) Foreign Application Priority Data
Aug. 25, 2020 (CN) 202021798918.2

(51) Int. Cl. F16K 15/02; F16K 25/00

(52) U.S. Cl. CPC F16K 15/026; F16K 25/00

(57) ABSTRACT

The present application provides a backflow prevention device, and relates to a backflow prevention technical field. Such a backflow prevention device includes a shell seat, a one-way mechanism and a flow controller. The shell seat is provided with a water channel therein, the one-way mechanism is assembled in the water channel, and the flow controller is assembled in the water channel and located upstream of the one-way mechanism. When the water flows through in a forward direction, the water first passes through the flow controller, and then pushes a movable plug of the one-way mechanism to move forward, so that the water flows forward from a periphery of the movable plug along the water channel and finally passes through a bottom cover of the one-way mechanism.

### TECHNICAL FIELD

The present application relates to a backflow prevention technical field, and in particular, to a backflow prevention device.

### BACKGROUND

A backflow prevention device is widely used in sanitary ware and other fields to prevent water from flowing backward.

At present, the backflow prevention device includes a one-way valve and other devices. When water flows through in a forward direction, in this kind of one-way valve, a movable rod disposed therein will move forward and penetrate through the one-way valve. Since in the existing sanitary product, a flow controller is usually disposed in front of the one-way valve, there needs to be a certain gap between the one-way valve and the flow controller. As a result, in some products with limited spaces, the one-way valve and the flow controller cannot be installed at the same time, otherwise, a problem of interference therebetween will be caused.

In view of this, the inventor specifically proposes the present application after studying the existing technology.

### SUMMARY OF APPLICATION

The present application provides a backflow prevention device, which aims to improve a problem that interference may occur in a backflow prevention device due to limitation of a installing space and a flow controller in the prior art.

In order to resolve the above technical problem, the present application provides a backflow prevention device, including a shell seat in which a water channel is disposed, a one-way mechanism assembled in the water channel, and a flow controller assembled in the water channel and located upstream of the one-way mechanism, wherein the one-way mechanism includes a bottom cover assembled on the shell seat, an elastic member supported on the bottom cover, and a movable plug that is supported on the elastic member and can move forward and backward relative to the water channel, and a side wall of the water channel is provided with a plurality of guide rib plates that are arranged uniformly.

As further optimization, the backflow prevention device further includes a filter seat assembled on the shell seat and located upstream of the flow controller.

As further optimization, the filter seat is a bamboo-hat-shaped geometry having an opening facing the flow controller, and a conical surface of the filter seat is provided with a plurality of filter holes that penetrate up and down.

As further optimization, the side wall of the water channel is provided with a sealing surface that shrinks inward, and a large end of the sealing surface is far away from the flow controller.

As further optimization, a bottom portion of the guide rib plate is provided with an inclined portion that is connected to the sealing surface.

As further optimization, a side of the movable plug facing the flow controller is provided with a first groove, and the first groove is located at a center of the movable plug.

As further optimization, a bottom surface of the first groove is a spherical surface having an opening facing upward.

By using the above technical solution, the present application can produce following technical effects:

1. The backflow prevention device of the present application simultaneously includes a one-way mechanism and a flow controller, thus, there is no need to dispose two mechanisms for respectively installing the one-way mechanism and the flow controller in a water outlet device, which simplifies an installation structure. Moreover, since the one-way mechanism of the present application is located downstream of the flow controller, when the water flows through, a movable plug of the one-way mechanism will not interfere the flow controller, which greatly decreases a space that needs to be avoided in front of the backflow prevention device, and enables the backflow prevention device to be installed in the water outlet device with a limited space, thereby having good practicability.

2. The backflow prevention device of the present application is provided with a filter seat upstream of the flow controller thereof, which makes the backflow prevention device have functions of filtering, flow controlling and one-way water flowing at the same time.

3. The backflow prevention device of the present application enables the movable plug to be better sealed on the sealing surface by disposing the sealing surface and the guide rib plates.

### BRIEF DESCRIPTION OF THE DRAWINGS

In order to illustrate technical solutions of embodiments of the present application more clearly, the figures required to be used in the description of the embodiments will be introduced briefly below. It should be understood that the following figures merely illustrate some of the embodiments of the present application, and thus should not be regarded as the limitations of the scope. For those skilled in the art, other figures can be obtained according to these figures without exerting any creative effort.

FIG. 1 is a schematic diagram of a shaft side structure of a backflow prevention device according to an embodiment of the present application;

FIG. 2 is a schematic diagram of a cross-sectional structure of the backflow prevention device according to an embodiment of the present application;

FIG. 3 is a schematic diagram of an exploded structure of the backflow prevention device according to an embodiment of the present invention; and

FIG. 4 is a schematic diagram of a sectional structure of a shell seat according to an embodiment of the present application.

Reference signs in the figures: 100: shell seat; 200: one-way mechanism; 300: flow controller; 400: filter seat; 110: water channel; 120: second sealing ring; 130: guide rib plate; 131: inclined portion; 140: sealing surface; 210: movable plug; 211: first groove; 220: elastic member; 230: bottom cover; and 410: filter hole.

### DETAILED DESCRIPTION OF THE EXEMPLARY EMBODIMENTS

The present application will be described in detail in conjunction with the accompanying drawings and the exemplary embodiments:

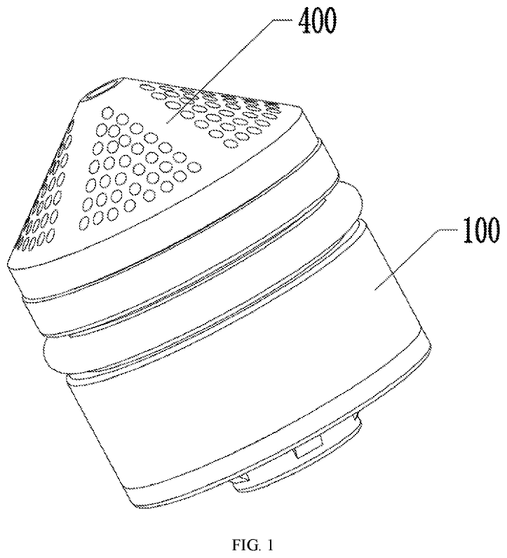

as shown from FIG. 1 to FIG. 4, the present embodiment provides a backflow prevention device, including; a shell seat 100, a one-way mechanism 200, a flow controller 300 and a filter seat 400. It is specifically as follows:

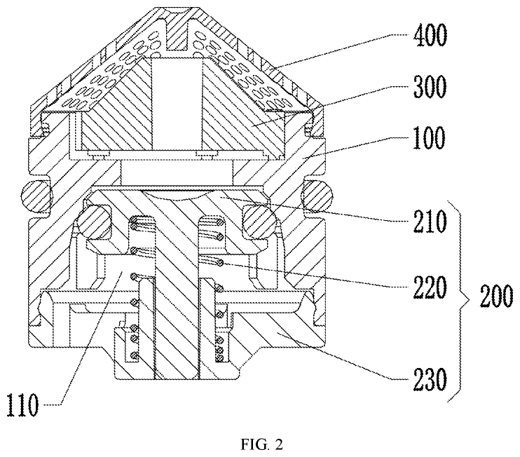

As shown in FIGS. 2, 3 and 4, in the present embodiment, the shell seat 100 is a cylindrical body, which adapts to an inner channel of a pipe or a water outlet device, such as a faucet, sprinkler or the like. The shell seat 100 is provided with a water channel 110 that penetrates up and down, and a second sealing ring 120 is sleeved on a peripheral surface of the shell seat 100.

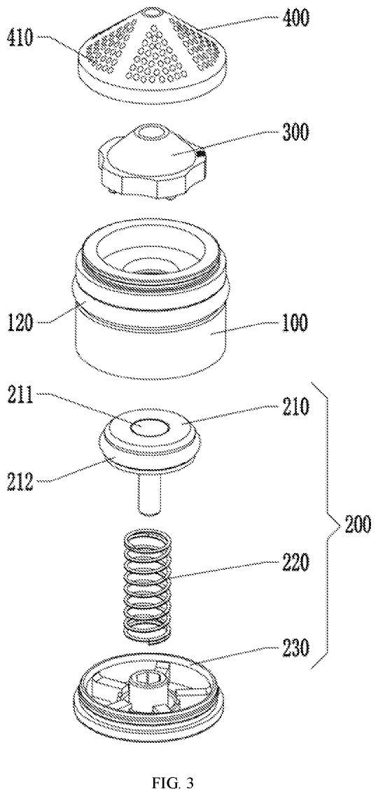

As shown in FIGS. 2 and 3, in the present embodiment, the one-way mechanism 200 includes a bottom cover 230 assembled on the shell seat 100, an elastic member 220 supported on the bottom cover 230, and a movable plug 210 that is supported on the elastic member 220 and can move forward and backward relative to the water channel 110. Wherein, the bottom cover 230 is engaged to a lower portion of the shell seat 100, provided with a hole in communication with the water channel 110, and provided with a cylindrical protrusion that protrudes upward at a center thereof; the elastic member 220 is a spring that is supported on the bottom cover 230 and sleeved on the cylindrical protrusion; the movable plug 210 has a plug tray portion and a plug rod portion, and is supported on the elastic member 220 by a means of inserting the plug rod portion in the elastic member 220. The plug tray portion is sleeved with a first sealing ring. Certainly, in another embodiment, the elastic member 220 may be an elastic body made of a rubber, such as: a rubber elastic sleeve, or an elastic steel sheet made of a steel sheet, which will not be repeated here.

As shown in FIGS. 2 and 3, in the present embodiment, the follow controller 300 is assembled on a step of the water channel 110, and located upstream of the one-way mechanism 200. The filter seat 100 is engaged on the shell seat 100, located upstream of the flow controller 300, and provided with a plurality of filer holes 410 that penetrate up and down. Wherein, the flow controller 300 is an existing device in the art, which will not be repeated here.

In specific operation, when the water flows through in a forward direction, the water first passes through the filter holes 410, then passes through the flow controller 300, and subsequently pushes the movable plug 210 to move forward to enable the plug rod portion to pass through the bottom cover 230, so that the water flows forward from a periphery of the movable plug 210 along the water channel 110 and finally passes through the bottom cover 230. When the water flows in a reverse direction, the water will pass through the bottom cover 230 and act on the movable plug 210, so that the movable plug 210 is more tightly fitted on the shell seat 100, which leads to that the water cannot pass through the water channel 100 in the reverse direction.

It should be explained that in the present embodiment, since the backflow prevention device of the present application simultaneously includes the one-way mechanism 200 and the flow controller 300, there is no need to dispose two mechanisms for respectively installing the one-way mechanism 200 and the flow controller 300 in the water outlet device, which can simplify the installation structure. Moreover, since the one-way mechanism 200 of the present application is located downstream of the flow controller 300, when the water flows through, the movable plug 210 of the one-way mechanism 200 will not interfere the flow controller 300, which greatly decreases a space that needs to be avoided in front of the backflow prevention device, and enables the backflow prevention device to be installed in the water outlet device with a limited space, thereby having good practicability.

As shown in FIGS. 2 and 3, in the present embodiment, the filter seat 400 is a bamboo-hat-shaped geometry having an opening facing the flow controller 300, and a conical surface of the filter seat 400 is provided with a plurality of filter holes 410 that penetrate up and down. The filter seat 400 of such a structure can accumulate filtered debris as far as possible to the periphery, which increases a filtering time of the filter seat 400. In addition, the disposition of the filter seat 400 can increase working reliability of the one-way mechanism 200 and avoid failure of the one-way mechanism 200 due to the debris.

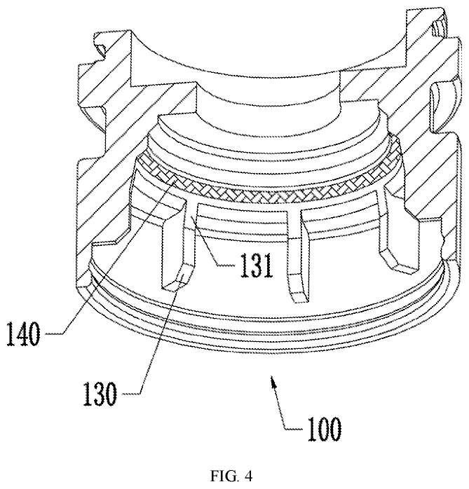

As shown in FIGS. 2 and 4, the present embodiment, the side wall of the water channel 100 is provided with a sealing surface that shrinks inward and a plurality of guide rib plates 130 that are arranged uniformly. A large end of the sealing surface 140 is disposed in a direction far away from the flow controller 300. In addition, a bottom portion of the guide rib plate 130 is provided with an inclined portion 131 that is connected to the sealing surface 140. Wherein, the guide rib plates 130 can also perform a guiding function to avoid a large angle of deflection when the movable plug 210 moves while strengthening the structure of the shell seat 100. The inclined portion 131 can perform a further guiding function when the movable plug 210 approaches the inclined portion 131, so that the movable plug 210 can be accurately sealed on the sealing surface 140. In addition, in the present embodiment, the sealing surface 140 that shrinks inward can enhance tightness between the sealing surface 140 and the movable plug 210.

In addition, as shown in FIG. 3, in the present embodiment, a side of the movable plug 210 facing the flow controller 300 is provided with a first groove 211, and the first groove 211 is located at a center of the movable plug 210. Wherein, a bottom surface of the first groove 211 is a spherical surface having an opening facing upward. Since the movable plug 210 is generally a plastic member, the disposition of the first groove 211 can avoid problems such as shrinkage caused by excessive thickness at this location and so on. In addition, when the water flows through, the first groove 211 is conductive to the balance of movement of the movable plug 210.

According to the above technical solution of the present embodiment, the backflow prevention device of the present case has functions of filtering, flow controlling and one-way water flowing at the same time. Moreover, the flow controller 300 is located upstream of the one-way mechanism 200, so that when the water flows through, the one-way mechanism 200 will not interfere the flow controller 300, the backflow prevention device can be installed in the water outlet device with a limited space, thereby having good practicability.

The above-described are merely the preferable embodiments of the present application, which are not used to limit the present application. For those skilled in the art, the present application can have various modifications and changes. Any amendments, equivalent replacements and improvements made without departing from the spirit and scope of the present application should be included in the protection scope of the present disclosure.

What is claimed is:

1. A backflow prevention device, comprising a shell seat (100) in which a water channel (110) is disposed, a one-way mechanism (200) assembled in the water channel (110) and a flow controller (300) assembled in the water channel (110) and located upstream of the one-way mechanism (200),
wherein the one-way mechanism (200) comprises a bottom cover (230) assembled on the shell seat (100), an elastic member (220) supported on the bottom cover (230) and a movable plug (210) that is supported on the elastic member (220) and can move forward and backward relative to the water channel (110), and a side wall of the water channel (110) is provided with a plurality of guide rib plates (130) that are arranged uniformly.

2. The backflow prevention device of claim 1, wherein the backflow prevention device further comprises a filter seat (400) assembled on the shell seat (100) and located upstream of the flow controller (300).

3. The backflow prevention device of claim 2, wherein the filter seat (400) is a bamboo-hat-shaped geometry having an opening facing the flow controller (300), and a conical surface of the filter seat (400) is provided with a plurality of filter holes (410) that penetrate up and down.

4. The backflow prevention device of claim 1, wherein the side wall of the water channel (110) is provided with a sealing surface (140) that shrinks inward, and a large end of the sealing surface (140) is far away from the flow controller (300).

5. The backflow prevention device of claim 4, wherein a bottom portion of the guide rib plate (130) is provided with an inclined portion (131) that is connected to the sealing surface (140).

6. The backflow prevention device of claim 1, wherein a side of the movable plug (210) facing the flow controller (300) is provided with a first groove (211), and the first groove (211) is located at a center of the movable plug (210).

7. The backflow prevention device of claim 6, wherein a bottom surface of the first groove (211) is a spherical surface having an opening facing upward.
